(19) United States
(12) Patent Application Publication
(10) Pub. No.: US 2015/0254777 A1
(43) Pub. Date: Sep. 10, 2015

(54) BEHAVIOURAL FINANCE INVESTMENT COACHING SYSTEM, SOFTWARE AND METHOD

(71) Applicant: Sciteb Ltd., London (GB)

(72) Inventor: Nicholas BEALE, London (GB)

(73) Assignee: Sciteb Ltd., London (GB)

(21) Appl. No.: 14/198,921

(22) Filed: Mar. 6, 2014

(51) Int. Cl. G06Q 40/06

(52) U.S. Cl. CPC G06Q 40/06

(57) ABSTRACT

A system and method and software for implementation thereof is disclosed for investment monitoring and coaching based on behavioural finance in which investors performance can be monitored and analysed allowing their irrational investment ‘behavioural biases’ (herein termed behavioural biases) to be identified. The computer-implemented method for investment monitoring and coaching comprises: by a computer, analysing said data representative of proposed investment decisions of an investor operating in a financial market to identify, based on data representative of that investor's history of investment decisions, the likely presence of a behavioural bias in an investment decision by said investor; and by a computer, generating one or more behavioural bias intervention alerts for an investor based on output from said one or more behavioural finance analysis engines.

### INTRODUCTION

The disclosure includes a system and method and software for implementation thereof for investment monitoring and coaching. The system can be used, for example, by an Investment Management Firm to improve their clients' investment performance by helping them avoid some of the standard errors that are made by human investors.

Investors active in financial markets endeavour to make informed and rational investment decisions when buying and selling interests in an attempt to cause the overall value of their investment portfolio to grow in the longer term. However, quite often when an investor attempts to make what at the time are considered to be rational investment choices, in many cases these investment choices may turn out to be sub-optimal, particularly with the benefit of hindsight.

Many investors can expend considerable time and effort in honing their investment strategies and yet still be unable to improve the objective performance of their investment portfolio relative to the market, and struggle to understand why that is the case.

### BRIEF DESCRIPTION OF THE DRAWINGS

FIG. 1 is a block diagram showing an embodiment of the system thereof for investment monitoring and coaching disclosed herein; and

FIG. 2 is a system diagram illustrating an embodiment of a hardware implementation of the systemic risk transfer system disclosed herein.

### DETAILED DESCRIPTION OF CERTAIN EXEMPLARY EMBODIMENTS

Behavioural Finance is the study of financial markets and investor behaviour from the perspective that human investors depart from “rational” behaviour. The fact that this occurs can now be considered scientifically established, and indeed some of the neuro-scientific and evolutionary bases of this behaviour are now becoming clear. The kinds of behavioural errors that are well-studied include:
I. Overconfidence.
   Humans almost invariably over-estimate the certainty with which they “know” uncertain information. For example, if asked to give 90% confidence intervals for 10 numbers that they don't precisely know, most humans will produce bands that are exceeded in about 30% of the cases. Similarly humans will tend to think there is a 90% chance of an investment gain when in fact there is only (at best) a 30% chance.
II. Loss Aversion
   Apart from tax, the price at which an investor acquired an investment is irrelevant to the price at which it is sensible to dispose of a stock. However human investors are typically reluctant to crystallise losses by selling stocks at prices lower than their acquisition costs.
III. Irrelevant framing.
   Humans tend to respond to “framing” information even when it is entirely irrelevant to the decision in hand. For example seeing a particular number displayed (say 3) will make people more likely to estimate an unknown number as being 3 or starting with a 3.
IV. Fast thinking for slow problems.
   It is well understood that certain rules-of-thumb appear to be “hard wired” into the human brain to make quick decisions when it is advantageous to do so. However these notoriously conflict with arithmetical reality. For example many people will suppose (especially if asked quickly) that “50% extra free” is worth the same as, or even more than, “50% off”.
V. Influence of hormones and bio-rhythms on risk appetite and other decision-making functions.
   It is also well understood that human's risk-appetites and other decision-making functions are influenced by hormonal factors. This can be particularly striking in the case of dealing rooms where “pack-like” behaviour has been observed. However hormone levels have also been observed to influence individual investment behaviour. It is also well-known that certain cognitive tasks are performed poorly when the decision-maker is extremely tired for example.

All of these behavioural biases are capable of significantly reducing investment performance. Indeed the fact that they occur can be considered one of the few sets of well-established scientific facts about investment performance.

The present applicant has recognised that individual and institutional investors would benefit greatly if they could avoid the irrational behavioural biases to which they may be prone.

In view of the above realisation, the applicant provides herewith a disclosure of a system and method and software for implementation thereof for investment monitoring and coaching based on behavioural finance in which investor's performance can be monitored and analysed allowing their irrational investment ‘foibles’ (herein termed behavioural biases) to be identified. A user of the system of the present disclosure is then warned of those behavioural biases when making future investment decisions so that the subjective and irrational decisions to which that user has been found to be prone can thus be avoided.

Viewed from one aspect, the present disclosure provides a computer-implemented method for investment monitoring and coaching comprising: by a computer, analysing said data representative of proposed investment decisions of an investor operating in a financial market to identify, based on data representative of that investor's history of investment decisions, the likely presence of a behavioural bias in an investment decision by said investor; and by a computer, generating one or more behavioural bias intervention alerts for an investor based on output from said one or more behavioural finance analysis engines.

In embodiments, said behavioural bias intervention alerts are provided to an investor by one of a plurality of intervention engines.

In embodiments, the intervention engine is selected from the plurality of intervention engines so as to be appropriate for a particular investor.

In embodiments, the selection of the intervention engine for a particular investor includes, by a computer, operating a matching engine to match the appropriate intervention engine to the investor.

In embodiments, the method further comprises monitoring an investor's response to behavioural bias intervention alerts generated by said intervention engine and adapting said intervention engine to improve said response.

In embodiments, analysing said data representative of proposed investment decisions for the likely presence of a behavioural bias includes identifying the possible presence of one or more of the group of biases comprising: overconfidence; loss aversion; irrelevant framing; inappropriate use of a rule-of-thumb; influence of hormones and bio-rhythms.

In embodiments, the method further comprises, by a computer, monitoring said investor's investment decisions in an on-going manner and analysing said investment decisions to identify said investor's sources of behavioural bias.

In embodiments, analysing said data representative of proposed investment decisions for the likely presence of a behavioural bias is performed by one or more behavioural finance analysis engines for analysing data representative of proposed investment decisions being made by investors operating in a financial market, said behavioural finance analysis engines being capable of identifying the likely presence of a behavioural bias in an investment decision by said investor.

In embodiments, said one or more behavioural finance analysis engines are generated for each investor based on data representative of that investor's history of investment decisions.

In embodiments, the method further comprises, by a computer, monitoring said investor's investment decisions in an on-going manner and adapting said one or more behavioural finance analysis engines to improve their detection rate of behavioural biases for that investor.

Viewed from another aspect, the present disclosure provides a system for investment monitoring and coaching comprising: one or more behavioural finance analysis engines for analysing data representative of proposed investment decisions being made by investors operating in a financial market, said behavioural finance analysis engines being capable of identifying the likely presence of a behavioural bias in an investment decision by said investor, said behavioural finance analysis engines having been generated for each investor based on data representative of that investor's history of investment decisions so as to be able to identify the degree to which that investor is susceptible to a given behavioural bias when making investment decisions; and an behavioural bias intervention alert generator engine for generating one or more investment decision intervention alerts for an investor based on output from said one or more behavioural finance analysis engines.

Viewed from another aspect, the present disclosure provides computer software for investment monitoring and coaching comprising instructions which when carried out by one or more processors of a computing system, cause the computing system to: analyse said data representative of proposed investment decisions being made an investor operating in a financial market to identify, based on data representative of that investor's history of investment decisions, the likely presence of a behavioural bias in an investment decision by said investor; and generate one or more behavioural bias intervention alerts for an investor based on output from said one or more behavioural finance analysis engines.

By the system, software and method of the present disclosure, e.g. an Investment Management Firm is enabled to help its investors avoid some or ideally most of the losses that would otherwise be caused by behavioural errors, by:
a. Scanning investor behaviour for investment decisions that may be examples of behavioural errors/behavioural biases (either those listed above or others).
b. Providing appropriate “coaching-like” interventions that will help reduce these errors.

And optionally:
c. Continuously learning from the success (or otherwise) of these interventions to devise better interventions and detection mechanisms.
d. Observing investor behaviour to identify new sources of behavioural bias that may be corrected to mutual advantage.

The system and method of the present disclosure can of course be used by individual and institutional investors in other ways and can be deployed in many different manners.

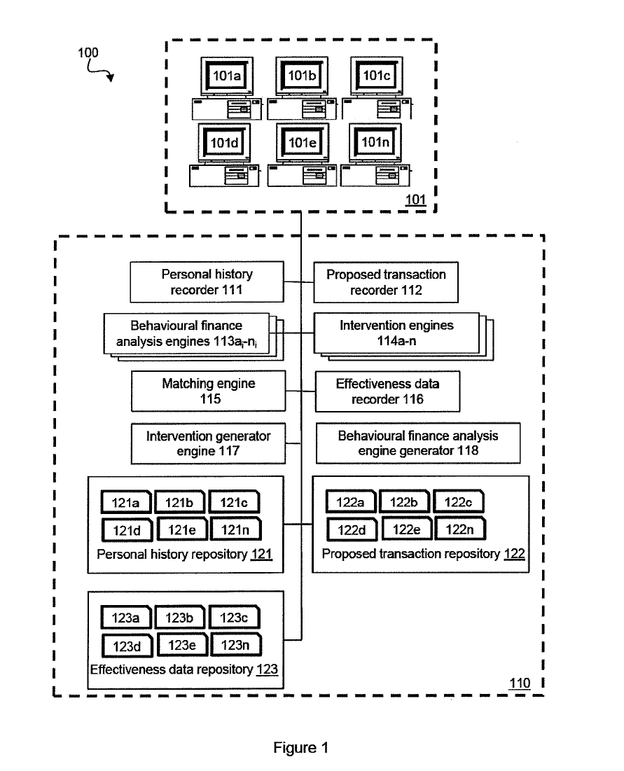

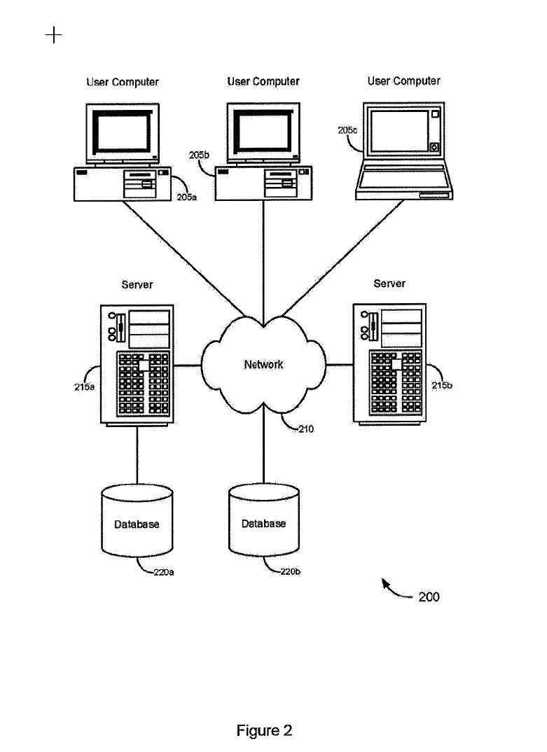

Referring now to FIGS. 1 and 2, there is provided a system 100 for investment monitoring and coaching. The system 100 comprises a number of coupled logical components 111-118 (described in detail below) implementing an investment monitoring and coaching engine 110. The investment monitoring and coaching engine 110 may be implemented across one or more processing devices or computers (such as user computers 205a-c and servers 215a,b) coupled by a network or bus, by one or more cooperating hardware and/or software elements instantiated in volatile or non-volatile memory of said computers (not shown).

The system 100 also comprises a number data repositories 121-123 (also detailed below) which are logically coupled to one or more of the logical components 111-118. The data repositories 121-123 may be stored in one or more databases 220a,b which may be coupled to one or more user computers 205a-c and servers 215a,b by e.g. a direct physical connection (such as by being integral therewith by being implemented in a local volatile or non-volatile memory thereof (not shown)) or by means of being coupled to a network 210.

In use, the investors will typically operate one or more user computers 205a-c that implement software to enable the user to monitor financial markets and their investment portfolios and to issue investment decisions, such as to buy or sell a particular volume of stock or other asset class in their portfolio. User computers 205a-c may be general purpose computing devices and may be embodied as networked desktop computers, laptops, tablets, smartphones, palm computers, etc. Alternatively, user computers 205a-c may be operated by operatives of an Investment Management Firm in response to investment decisions issued by an investor, for example, over the phone.

In the system 100 shown in FIG. 1, investors 101a-n operate user computers 101 coupled to a server 110 that implements the method and software disclosed herein to provide the investment monitoring and coaching engine 110.

The system 100 includes a personal history recording means 111, a logical component for recording the personal histories of each of the individual or institutional investors 101a . . . n that wish to benefit from the coaching system. The recorded data would include investment portfolios and investment decisions that the investors 101a . . . n have made together with any available background information about them (age, gender, occupation, address, family circumstances). The personal history recording means 111 continually monitors an investor's activities and records them in a personal history record 121a . . . n for each investor 101a . . . n in personal history repository 121.

The personal history recording means 111 may also record the timings of the interactions in the personal histories, both in absolute and relative terms. Information about the times of the day in which an investor typically interacts with the system will give some insights into their psychological profile, as will information about the speed of reaction, since in general intuitive decisions tend to be taken faster than more “rational” ones.

The system 100 also includes a proposed transaction recording means 112, a logical component for recording the transactions proposed by each investor 101a . . . n. This information would normally be captured by the user interface (whether web-based or an app or otherwise) offered to the investor. Alternatively, it could be captured by a data entry system if, for example, the investors interacted over the telephone. In some cases the proposed transaction will only be “captured” when the investor actually attempts to buy or sell an investment, but in other cases it may be possible to capture the fact that the investor is contemplating an investment and researching a stock—in which case such information of course should also be recorded by the personal history recorder 111 above. The proposed transaction recording means 112 continually monitors an investor's intended transactions and records them in a proposed transaction record 122a . . . n for each investor 101a . . . n in proposed transaction repository 122.

The system 100 further comprises a plurality of behavioural finance analysis engines 113aᵢ-nᵢ, or “Foible Scanners” which are algorithmic systems designed to estimate the probability that a given investor is subject to a particular behavioural bias or “foible” such as those identified above.

There are a wide variety of ways in which behavioural finance analysis engines could be built. Some possibilities are discussed here by way of example:
A. A Bayesian behavioural finance analysis engine would hold an explicit prior probability for each investor of being susceptible to the behavioural bias in question. Faced with a particular proposed transaction there would then be a likelihood of this transaction if the investor had this behavioural bias and a likelihood if the investor was fully rational. Denoting these likelihoods by L_{F} and L_{R} and the prior probability by p0 then the posterior probability p₁ of suffering from this behavioural bias can be calculated in the classical manner with Bayes' Theorem as p₁=P₀×L_{F}/L_{R}.
B. An Evolutionary behavioural finance analysis engine would estimate a Behavioural bias Score (say from 0-10) based on a set of explicit calculations from the information held in the records stored in personal history repository 121 and the proposed transaction (from repository 122) that was developed by means of an evolutionary algorithm. To be more specific, an evolving population of candidate Behavioural finance analysis engines 113ai-ni would be “bred” in the system using normal techniques of evolutionary algorithms, with “fitness” based on the success in identifying investors who then accept intervention for this particular behavioural bias (see description of intervention engines below).
C. Behavioural finance analysis engines may be based on Pattern Recognition or Neural Network techniques. These would be trained in the classical manner by looking at situations where investor have accepted, and not accepted, interventions for this particular behavioural bias (see description of intervention engines below).
D. Behavioural finance analysis engine may implement explicit special purpose algorithms based on research findings on a particular behavioural bias.

The system 100 also comprises a plurality of Intervention Engines 114a-n. These are algorithms designed to assist investors in overcoming particular behavioural biases. These Intervention Engines 114a-n can come in a wide variety of styles and it is an important aspect of the present system 100 that the style will be matched appropriately for the investor, depending on “the psychology of the individual”. As with the behavioural finance analysis engines 113aᵢ-nᵢ above, there are a great many possibilities of how these intervention engines 114a-n would be constructed, and within reason the greater variety the better. The following are some examples of the types of intervention engines 114a-n that can be constructed in accordance with the system 100 of the present disclosure:
A. Intervention Engines may be of the “Metaphor” type, in that they can adopt different “metaphors” so as to allow for the range of possible effective approaches. For example many investors have a favourite sport or hobby at which they will accept coaching in some form. But the metaphors that would be effective to a keen golfer (“par”, “bogies”, “eagle”, “hook”, “slice”, “mulligan”) might mean nothing to a sailor and such terms as “luffing”, “spilling wind”, “transom drag” and “apparent wind” might mean nothing to a golfer. More to the point different metaphors are likely to be more effective with different people in terms of their willingness to accept coaching. There will even be a subset of investors who are happy to be talked to in economic or mathematical terms, or directly in the language of behavioural finance.
B. Intervention Engines may be of the “Persona” type, in that the way in which the interaction manifests itself to the investor is by differed personae or avatars. This could range from simple text-based communication to the adoption of an avatar or indeed the persona of a real person living or dead. For example, a well-known mentor or successful investor may lend their image to be used, which some investors may find more persuasive and may as a result be more receptive to the alerts. Some investment management firms might have leading analysts or fund managers who would be willing for their Personae to be used, or it may be possible for celebrities or outside experts to offer their personae. Ideally these personae would not simply be differences in appearance and voice (in cases where they interacted with the investors in terms of on-screen avatars) but they would also be somewhat differentiated in terms of the examples they quoted and the vocabulary they used. This could be both at a very “superficial” level (eg a Ben Graham persona might say “as I wrote in The Intelligent Investor, the investor's chief problem—and even his worst enemy—is likely to be himself.”) whereas another persona might quote it and at a deeper level with the probability of using a particular quote or expression depending on the persona adopted.
C. Intervention Engines may be Motivational. Whereas it seems obvious that all investors are motivated by a desire to make money and that therefore the motivation offered for changing behaviour should be couched in simple financial terms, this is not necessarily the case. Investors' time horizons and risk appetites vary appreciably. In addition some investors may be more motivated by notions of relative skill or by an ability to give (say) 10% of their profits to charitable causes. So for one investor it may be very effective to say “This looks as if it might be an example of over-confidence which seems to have cost you about $130,000 in the last 3 years.” But other investors might react badly to an intervention cast in this style and prefer to be told “You could rise even higher in the league table of cool-headed investors” or “on average this would probably increase your charitable giving by over $10,000.”
D. Intervention Engines may vary in style in terms of how and to what extent the alert actually intervenes in or delays an investor's proposed trade. The most obvious aspect of this is whether the intervention will actually delay the proposed investment decision. For example, while some intervention engines may only provide advisory or ‘guidance’ alerts which an investor may pay attention to (or ignore), other intervention engines may actually prevent proposed investment decisions from being executed until the alert has been overridden. For obvious legal reasons this would require explicit permission from the investor—although finance theory suggests that market timing is so exceptionally difficult that there is no real expected loss in delaying a trade—but since the market will almost certainly have moved at least somewhat there will be an obvious loss about 50% of the time, and therefore investors will need to be educated in what the net costs of delaying their trades would have been over the last year (say).

The system 100 also comprises a matching engine 115 which attempts to match the appropriate type of intervention engine to the appropriate investor 101a-n. Again there are various possibilities for this, and a mixture of these approaches can be used. For example:
A. The matching engine 115 may allow an investor 101a-n some degree of explicit customisation of the matching intervention engine 114a-n. In many ways the simplest approach will be for the matching engine 115 to ask each Investor when they enroll in the system what type of intervention they want. This is somewhat akin to selecting your own avatar in a video-game or selecting the type of scenery you want to travel through on a bike simulator. The advantages of this approach are obvious: the investor gets what he or she selects. However there are also disadvantages:
   i. It makes it very salient how artificial the intervention persona is.
   ii. What the investor chooses may not in fact be the most effective form of intervention for them.
B. The matching engine 115 may make a selection of an investor's intervention engine 114a-n based on an analysis of the clustering of the results of the use of different types of intervention engine for different types of investor. An alternative is to select the intervention engines 114a-n. for the investors 101a-n based on a statistical analysis of what has worked or been acceptable for similar investors. This is based on the following approach:
   i. Measuring “fitness”. The key measure of success of an intervention is the extent to which they actually improve investment behaviour. Investors may find particular styles of intervention “nice” but if they do not in fact change their investment behaviour and persist in their behavioural biases then these interventions are probably not helpful. it is therefore important, whatever form of matching is used, that the effectiveness of each attempted intervention is measured and recorded by the overall system by effectiveness data recorder 116 (described below).
   ii. Using fitness to select intervention engines. Given a measure of fitness then in principle this can be used to select the appropriate intervention engine. If all investors were identical this would be straightforward, but of course they are not. Nevertheless there are various approaches whereby the fitness can be presumed to change on the basis of positioning each investor on a multi-dimensional “landscape”. One approach to this is to find the k nearest neighbours to this new investor where the fitness of given interventions is known and then interpolating the fitness from this.
      To give a simplified illustrative example, suppose there are 2 interventions A and B, that k=5 and on the 5 nearest neighbours the relative fitness (on a scale of 0-1) of these interventions is A:0.9, B:0.7; A:0.3; B:0.7; B:0.5. Then (assuming the simplest possible interpolation algorithm was used which did not take into account the actual distance from the neighbours, more sophisticated ones are possible but these have pros and cons that will be understood by those skilled in the art) the interpolated fitness for A would be 0.6 and for B would be 0.5.
      This interpolated fitness could be used to select the intervention deterministically (always picking the highest fitness) or probabilistically (having the probability of picking a given Intervention depend on the interpolated fitness—this is a generalisation of a deterministic selection and would usually be preferable to avoid the system becoming too much of a mono-culture.
      A variant of this approach might be to impute fitness separately to each of the components of the intervention approach (eg Metaphor, Persona, Motivation and Style above)
C. The matching engine 115 may take an evolutionary approach. Another approach based on using fitness is to adopt a genetic algorithm approach to developing suitable interventions, which is discussed in below in relation to the intervention generator engine 117.

The system 100 also includes an effectiveness data recorder 116, a logical component for monitoring the effectiveness of each intervention. The effectiveness data recorder 116 then stores the effectiveness data for each intervention for each intervention engine 114a-n as data records 123a-n in effectiveness data repository 123. The effectiveness data could alternatively be kept as a subset of the data in personal history repository 121.

Such data would include not only the actual “hard” outcome of each intervention but softer measures such as how long each Investor took to respond to an intervention, which will give an indication of the psychological impact.

In order to actually cause the system 100 to operate, there is provided an Intervention generator 117 for working with the behavioural finance analysis engines 113 aᵢ-nᵢ and intervention engines 114a-n to provide intervention alerts to investors 101 a-n. Rather than having a static repertoire of possible interventions, it is desirable that the system 100 should be able to generate new interventions over time. Again there are various approaches which can be used alone or in appropriate combinations:
A. Manual Generation/Improvement. This is the most obvious, with new Metaphors, Personae, Motivations and Styles being added in the light of research or indeed driven by possible external events. If for example a business or sporting icon decided he or she was willing to have their persona used (for a suitable consideration) in the system this would be an obvious possibility. Equally there are entirely fictitious personae that have become very popular for personal finance (eg the GEICO Gecko and in the UK the ComparetheMarket Meerkat) and could prove effective.
B. Evolutionary Approach. As noted in above, it is possible to use “fitness” in a genetic algorithm approach to developing suitable interventions. To give an outline of one possible approach:
   i. Adding mutation In addition to the possibility of choosing an intervention approach that worked for neighbours with a probability depending on fitness there could also be a probability p_{MI} of introducing a random mutation in the approach chosen. p_{MI} would typically be under 10% and possibly well under 1% depending on the number of investors in the system. These mutations would need to be viable and not so outlandish that the investor would complain (so you might not want the persona of a famous swimmer adopting golf metaphors, although there would be no problem for a famous business person doing the same).
   ii. Adding cross-breeding. Another possibility is to allow cross-breeding between two intervention approaches, with the resulting “offspring” having a randomly chosen mix of the characteristics of their two “parents.” This would typically be controlled by another parameter p_{MI} say which would be the probability that cross-breeding would be attempted. The simplest version of this would be to allow cross-breeding between arbitrarily selected pairs of interventions with the probability distributions for selection dependent on fitness and/or the prevalence of these intervention approaches in the population as a whole (given that each Investor will generally have an intervention approach attached to him/her—which will in the long run tend to lead to there being more instances of the more successful intervention approaches).
   iii. Trial Viability. It would generally be inappropriate to release such evolved interventions “into the wild” on investors without a suitable level of screening. Paid testers or suitably rewarded volunteers might be used to ensure that the evolved interventions were not too outlandish to be effective, and to allocate them preliminary fitness scores. But it needs to be remembered that interventions which would be quite hopeless for some people would be highly effective with others, and therefore the screening should not be too ruthless.
C. Interactive improvement. Another approach is based an explicitly seeking feedback from the investors on how they would like their interventions improved. This can of course go beyond collecting suggestions which are then incorporated into the manual generation/improvement. The interventions can be modified directly in line with the investor feedback, although again a balance needs to be struck since if the interventions are too “plastic” they may not be effective.

Finally, the system 100 also includes behavioural finance analysis engine generator 118, a logical component providing means to develop new behavioural finance analysis engines 113aᵢ-nᵢ, either improving on the scanning of existing behavioural biases or in the detection of new behavioural biases, are also highly desirable. There is much conceptual similarity between this and the problem of intervention generators, although there are some differences.
A. Manual Generation/Improvement. This is the most obvious, especially given the rapid developments in behavioural economics and the likely continued development over the coming decades in this and related fields such as Neuro-economics and even in the understanding of how genetic factors impact investment risk appetite.
B. Evolutionary Approach. As in 7(b) above, it is possible to use “fitness” in a genetic algorithm approach to developing suitable interventions. In this case “fitness” can be interpreted in various ways but the most natural is as a rate of detection of behavioural biases which are acknowledged by the investor and lead to successful interventions (but see the discussion in iii below). Again this is an outline and details and refinements can readily be added by those skilled in the art:
   i. Adding mutation In addition to the possibility of choosing a behavioural finance analysis engine that worked for neighbours with a probability depending on fitness there could similarly be a probability p_{MF} of introducing a random mutation in the approach chosen. p_{MF} would typically be under 10% and possibly well under 1% depending on the number of investors in the system. These mutations would need to be viable and not so outlandish that the investor would complain. The simplest types of mutation would be adjusting some of the estimation parameters in terms of time delay, weighting and so forth. However there is also the possibility of more radical mutations if the behavioural finance analysis engines 113ai-ni are represented in an algorithmic format that allows for mutation of the algorithms in a constructive way.
   ii. Adding cross-breeding. Another possibility is to allow cross-breeding between two intervention approaches, with the resulting “offspring” having a randomly chosen mix of the characteristics of their two “parents.” As described above there are various possibilities of how the cross-breeding pairs are selected. It may be better to avoid cross-breeding with two behavioural bias detectors that are too similar because this will introduce too little variety/innovation. Equally the probability of “cross-breeding” between two behavioural bias detectors that detect very different types of behavioural bias may be set lower than the probability of cross-breeding between behavioural finance analysis engines 113aᵢ-nᵢ looking for behavioural biases of the same type.
   iii. Trial Viability. The striking difference between behavioural finance analysis engine generation and intervention generation lies in the ability to back-test using data. The success of behavioural finance analysis engines 113aᵢ-nᵢ can be thought of as being a product of the rate at which they reliably detect behavioural biases and the rate at which they are acknowledged (even though the latter depends on the Interventions that are used as well). Unlike new intervention engines 114a-n which require human evaluation to see if they are reasonable, the detection rates, and false positive rates, of behavioural finance analysis engines 113aᵢ-nᵢ can be evaluated in silico based on going through past personal histories if investors who are known (or believed) to have certain behavioural biases and observing the speed and reliability with which the behavioural biases would have been identified by new engines.
C. Statistical improvement. The point about back-testing above leads to the observation that one can apply any of the well-known statistical estimation techniques to develop and improve behavioural finance analysis engines 113a₁-nᵢ. Indeed if human behaviour only had a very few dimensions this would be a well-formed statistical problem. However the fact that there may be millions of items of data about each investor means that fully-specified optimal algorithms are not available.
D. Interactive improvement. Another approach is based on explicitly seeking feedback from the investors on how they would like their interventions improved. This can of course go beyond collecting suggestions which are then incorporated into the manual generation/improvement. The interventions can be modified directly in line with the investor feedback, although again a balance needs to be struck since if the interventions are too “plastic” they may not be effective.

Merely by way of example, FIG. 2 illustrates a schematic diagram of a system 200 that can be used in accordance with one set of embodiments. The system 200 can include one or more user computers 205. The user computers 205 can be general purpose personal computers (including, merely by way of example, personal computers and/or laptop computers running any appropriate flavour of Microsoft Corp.'s Windows™ and/or Apple Corp.'s Macintosh™ operating systems) and/or workstation computers running any of a variety of commercially available UNIX™ or UNIX-like operating systems. These user computers 205 can also have any of a variety of applications, including one or more applications configured to perform methods of the invention, as well as one or more office applications, database client and/or server applications, and web browser applications. Alternatively, the user computers 205 can be any other electronic device, such as a thin-client computer, Internet-enabled mobile telephone, and/or personal digital assistant (PDA), capable of communicating via a network (e.g., the network 210 described below) and/or displaying and navigating web pages or other types of electronic documents. Although the exemplary system 200 is shown with three user computers 205, any number of user computers can be supported.

Certain embodiments of the invention operate in a networked environment, which can include a network 210. The network 210 can be any type of network familiar to those skilled in the art that can support data communications using any of a variety of commercially available protocols, including without limitation TCP/IP, SNA, IPX, AppleTalk, and the like. Merely by way of example, the network 210 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infrared network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 215. Each of the server computers 215 may be configured with an operating system, including without limitation any of those discussed above, as well as any commercially (or freely) available server operating systems. Each of the servers 215 may also be running one or more applications, which can be configured to provide services to one or more user computers 205 and/or other server computers 215.

Merely by way of example, one of the server computers 215 may be a web server or an application server, which can include one or more applications accessible by a client running on one or more of the user computers 205 and/or other server computers 215. Merely by way of example, the server computers 215 can be one or more general purpose computers capable of executing programs or scripts in response to the user computers 205 and/or other server computers 215, including without limitation web applications (which might, in some cases, be configured to perform methods of the invention). The application server(s) can also include database servers, including without limitation those commercially available from Microsoft™, Sybase™, IBM™ and the like, which can process requests from clients (including, depending on the configuration, database clients, API clients, web browsers, etc.) running on a user computer 205 and/or another server computer 215. Data provided by an application server may be formatted as web pages (comprising HTML, Javascript, etc., for example) and/or may be forwarded to a user computer 205 via a web server (as described above, for example). In some cases a web server may be integrated with an application server.

In accordance with further embodiments, one or more server computers 215 can function as a file server and/or can include one or more of the files (e.g., application code, data files, etc.) necessary to implement methods of the invention incorporated by an application running on a user computer 205 and/or another server computer 215. Alternatively, as those skilled in the art will appreciate, a file server can include all necessary files, allowing such an application to be invoked remotely by a user computer 205 and/or server computer 215. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more database(s) 220. The location of the database(s) 220 is discretionary. Merely by way of example, a database 220a might reside on a storage medium local to (and/or resident in) a server computer 215a (and/or a user computer 205). Alternatively, a database 220b can be remote from any or all of the computers 205, 215, so long as the database can be in communication (e.g., via the network 210) with one or more of these.

The above-described system can be configured by software to implement the systems and methods for behavioural finance monitoring and coaching described herein with particular reference to FIG. 1.

Finally, although certain example methods, systems and software have been described herein, the scope of coverage of this disclosure is not limited thereto. On the contrary, this disclosure covers all methods, apparatus and articles of manufacture fairly falling within the scope of the appended claims either literally or under the doctrine of equivalents.

1. A computer-implemented method for investment monitoring and coaching comprising:
by a computer, analysing said data representative of proposed investment decisions of an investor operating in a financial market to identify, based on data representative of that investor's history of investment decisions, the likely presence of a behavioural bias in an investment decision by said investor; and
by a computer, generating one or more behavioural bias intervention alerts for an investor based on output from said one or more behavioural finance analysis engines.

2. A method as claimed in claim 1, wherein said behavioural bias intervention alerts are provided to an investor by one of a plurality of intervention engines.

3. A method as claimed in claim 2, wherein the intervention engine is selected from the plurality of intervention engines so as to be appropriate for a particular investor.

4. A method as claimed in claim 3, wherein the selection of the intervention engine for a particular investor includes, by a computer, operating a matching engine to match the appropriate intervention engine to the investor.

5. A method as claimed in claim 2, further comprising monitoring an investor's response to behavioural bias intervention alerts generated by said intervention engine and adapting said intervention engine to improve said response.

6. A method as claimed in claim 1, wherein analysing said data representative of proposed investment decisions for the likely presence of a behavioural bias includes identifying the possible presence of one or more of the group of biases comprising: overconfidence; loss aversion; irrelevant framing; inappropriate use of a rule-of-thumb; influence of hormones and bio-rhythms.

7. A method as claimed in claim 1, further comprising, by a computer, monitoring said investor's investment decisions in an on-going manner and analysing said investment decisions to identify said investor's sources of behavioural bias.

8. A method as claimed in claim 1, wherein analysing said data representative of proposed investment decisions for the likely presence of a behavioural bias is performed by one or more behavioural finance analysis engines for analysing data representative of proposed investment decisions being made by investors operating in a financial market, said behavioural finance analysis engines being capable of identifying the likely presence of a behavioural bias in an investment decision by said investor.

9. A method as claimed in claim 7, wherein said one or more behavioural finance analysis engines are generated for each investor based on data representative of that investor's history of investment decisions.

10. A method as claimed in claim 7, further comprising, by a computer, monitoring said investors investment decisions in an on-going manner and adapting said one or more behavioural finance analysis engines to improve their detection rate of behavioural biases for that investor.

11. A system for investment monitoring and coaching comprising:
one or more behavioural finance analysis engines for analysing data representative of proposed investment decisions being made by investors operating in a financial market, said behavioural finance analysis engines being capable of identifying the likely presence of a behavioural bias in an investment decision by said investor, said behavioural finance analysis engines having been generated for each investor based on data representative of that investor's history of investment decisions so as to be able to identify the degree to which that investor is susceptible to a given behavioural bias when making investment decisions; and
an behavioural bias intervention alert generator engine for generating one or more investment decision intervention alerts for an investor based on output from said one or more behavioural finance analysis engines.

12. Computer software for investment monitoring and coaching comprising instructions which when carried out by one or more processors of a computing system, cause the computing system to:
analyse said data representative of proposed investment decisions being made an investor operating in a financial market to identify, based on data representative of that investor's history of investment decisions, the likely presence of a behavioural bias in an investment decision by said investor; and
generate one or more behavioural bias intervention alerts for an investor based on output from said one or more behavioural finance analysis engines.
